(19) United States
(12) Patent Application Publication
(10) Pub. No.: US 2025/0305850 A1
(43) Pub. Date: Oct. 2, 2025

(54) MOVING OBJECT CONTROL SYSTEM, CONTROL METHOD THEREFOR, AND STORAGE MEDIUM

(71) Applicant: HONDA MOTOR CO., LTD., Tokyo (JP)

(72) Inventors: Kohei TSUDA, Wako-shi (JP); Ryoji WAKAYAMA, Wako-shi (JP)

(21) Appl. No.: 19/061,341

(22) Filed: Feb. 24, 2025

(30) Foreign Application Priority Data
Mar. 28, 2024 (JP) 2024-054476

(51) Int. Cl. G01C 21/00; G06T 7/11; G06T 7/13; G06T 7/50; G06V 20/58

(52) U.S. Cl. CPC G01C 21/3837; G06T 7/11; G06T 7/13; G06T 7/50; G06V 20/58; G06V 2201/07

(57) ABSTRACT

A moving object control system acquires a captured image, captured by a moving object, and depth information of an environment captured in the captured image, identifies a dynamic obstacle that is autonomously movable and included in the captured image by using the captured image, and generates an occupancy map indicating occupancy of an obstacle for each divided region obtained by dividing a peripheral region of the moving object, on a basis of the depth information. The occupancy map includes a first divided region indicating occupancy of the dynamic obstacle forgotten according to a forgetting rate higher than a forgetting rate of a static obstacle that does not autonomously move. The system sets the divided region in a depth direction that is away from the moving object from a position of the identified dynamic obstacle, as the first divided region.

### CROSS-REFERENCE TO RELATED APPLICATION(S)

This application claims priority to and the benefit of Japanese Patent Application No. 2024-054476, filed Mar. 28, 2024, the entire disclosure of which is incorporated herein by reference.

### BACKGROUND OF THE INVENTION

### Field of the Invention

The present invention relates to a moving object control system, a control method therefor, and a storage medium.

### Description of the Related Art

In these years, there is an increasing demand for ultra-compact moving objects (micro mobility vehicles) for supporting people's movement in small regions. Micro mobility vehicles require an autonomous movement technology for a free space such as a sidewalk in addition to an automated driving technology for traveling on a roadway in order to enable traveling in both vehicle movement regions and pedestrian movement regions. In an advancing direction of the micro mobility vehicle, it is assumed that there is an autonomously movable dynamic obstacle such as a bicycle in addition to a static obstacle that does not move.

Japanese Patent Laid-Open No. 2020-152234 discloses a technology of recognizing an object in a parking lot by an image recognition technique and reflecting a position of the recognized object on an environmental map, in an autonomously movable vehicle. In the technology disclosed in Japanese Patent Laid-Open No. 2020-152234, a static object such as a wall or a guardrail and a dynamic object such as an automobile or a person are discriminated according to the type of the object recognized by the image recognition, and the dynamic object is removed to generate an environmental map in which the static object is recorded as an obstacle.

Meanwhile, in a case where distance information regarding an obstacle around a moving object is detected using a detection unit such as a stereo camera, point cloud noise of distance information such as a shadow may occur in a depth direction away from the moving object around a contour of a dynamic obstacle (for example, person). Such point cloud noise can be accumulated such as an afterimage on a map as an obstacle existing separately from an obstacle such as a person. In such a case, there is a problem that the moving object causes generation of a travel path for unnecessarily avoiding a region that is originally a region where the moving object can travel without an obstacle.

### SUMMARY OF THE INVENTION

The present invention has been made in view of the above problems, and an object thereof is to provide a technology capable of reducing an influence of point cloud noise due to a dynamic obstacle around a moving object.

In order to solve the aforementioned issues, one aspect of the present disclosure provides a moving object control system comprising: one or more processors; and a memory storing instructions which, when the instructions are executed by the one or more processors, cause the moving object control system to function as: an acquisition unit configured to acquire a captured image captured by a moving object, and depth information of an environment captured in the captured image; an identification unit configured to identify a dynamic obstacle that is autonomously movable and included in the captured image by using the captured image; and a map generation unit configured to generate an occupancy map indicating occupancy of an obstacle for each divided region obtained by dividing a peripheral region of the moving object, on a basis of the depth information, wherein the occupancy map includes a first divided region indicating occupancy of the dynamic obstacle forgotten according to a forgetting rate higher than a forgetting rate of a static obstacle that does not autonomously move, and the map generation unit sets the divided region in a depth direction that is away from the moving object from a position of the identified dynamic obstacle, as the first divided region indicating the occupancy of the dynamic obstacle.

Another aspect of the present disclosure provides a control method for a moving object control system, the control method comprising: acquiring a captured image captured by a moving object, and depth information of an environment captured in the captured image; identifying a dynamic obstacle that is autonomously movable and included in the captured image by using the captured image; and generating an occupancy map indicating occupancy of an obstacle for each divided region obtained by dividing a peripheral region of the moving object, on a basis of the depth information, wherein the occupancy map includes a first divided region indicating occupancy of the dynamic obstacle forgotten according to a forgetting rate higher than a forgetting rate of a static obstacle that does not autonomously move, and the generating the occupancy map includes setting the divided region in a depth direction that is away from the moving object from a position of the identified dynamic obstacle, as the first divided region indicating the occupancy of the dynamic obstacle.

Still another aspect of the present disclosure provides a non-transitory computer-readable storage medium of storing a program for causing a computer to function as each unit of a moving object control system, wherein the moving object control system includes an acquisition unit configured to acquire a captured image captured by a moving object, and depth information of an environment captured in the captured image, an identification unit configured to identify a dynamic obstacle that is autonomously movable and included in the captured image by using the captured image, and a map generation unit configured to generate an occupancy map indicating occupancy of an obstacle for each divided region obtained by dividing a peripheral region of the moving object, on a basis of the depth information, the occupancy map includes a first divided region indicating occupancy of the dynamic obstacle forgotten according to a forgetting rate higher than a forgetting rate of a static obstacle that does not autonomously move, and the map generation unit sets the divided region in a depth direction that is away from the moving object from a position of the identified dynamic obstacle, as the first divided region indicating the occupancy of the dynamic obstacle.

According to the present invention, it is possible to reduce an influence of point cloud noise due to an obstacle around a moving object.

### BRIEF DESCRIPTION OF THE DRAWINGS

FIGS. 1A and 1B are block diagrams illustrating a hardware configuration example of a moving object according to the present embodiment;

FIG. 2 is a block diagram illustrating a control configuration of the moving object according to the present embodiment;

FIG. 3 is a block diagram illustrating a functional configuration of a control unit according to the present embodiment;

FIG. 4 is a diagram illustrating an occupancy grid map according to the present embodiment;

FIG. 5 is a diagram illustrating a generation method for the occupancy grid map according to the present embodiment;

FIG. 6A is a diagram for describing setting of grid cells of a dynamic obstacle and a static obstacle according to the present embodiment;

FIG. 6B is a diagram for describing another example of setting of grid cells of a dynamic obstacle and a static obstacle according to the present embodiment;

FIG. 7 is a diagram illustrating a global path and a local path according to the present embodiment;

FIG. 8 is a flowchart illustrating a processing procedure of controlling traveling of the moving object according to the present embodiment; and

FIG. 9 is a flowchart illustrating a processing procedure for forgetting accumulated obstacle information according to the present embodiment.

### DESCRIPTION OF THE EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

### <Configuration of Moving Object>

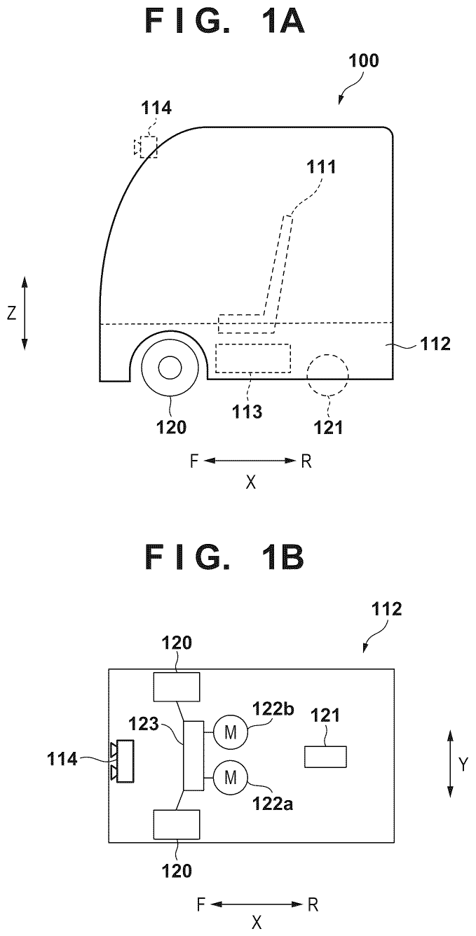

A configuration of a moving object 100 according to the present embodiment will be described with reference to FIGS. 1A and 1B. FIG. 1A illustrates a side view of the moving object 100 according to the present embodiment, and FIG. 1B illustrates an internal configuration of the moving object 100. In the drawings, an arrow X indicates a front-and-rear direction of the moving object 100, F indicates the front, and R indicates the rear. An arrow Y indicates a width direction (a left-and-right direction) of the moving object 100, and an arrow Z indicates an up-and-down direction of the moving object 100.

The moving object 100 is equipped with a battery 113, and is, for example, an ultra-compact mobility vehicle that is moved mainly by the power of a motor. The ultra-compact mobility vehicle is an ultra-compact vehicle that is more compact than a general automobile and has a seating capacity of about one or two persons. In the present embodiment, an ultra-compact mobility vehicle with three wheels will be described as an example of the moving object 100, but there is no intention to limit the present invention, and for example, a four-wheeled vehicle or a straddle type vehicle may be used. In addition, the moving object of the present invention is not limited to a mobility device, and may be a vehicle loaded with luggage and traveling alongside a person who is walking, or a vehicle leading a person. In addition, the moving object control system according to the present embodiment may be a moving object, a control apparatus such as an ECU included in the moving object, or an information processing server, which is configured to control the moving object, on a cloud. That is, a part or all of processing to be described later according to the present embodiment may be executed in the moving object or may be executed in the information processing server on the cloud. Furthermore, the present invention is not limited to a four-wheeled or two-wheeled vehicle, and can also be applied to a robot or the like capable of autonomous movement.

The moving object 100 is an electric autonomous vehicle including a traveling unit 112 and using the battery 113 as a main power supply. The battery 113 is, for example, a secondary battery such as a lithium ion battery, and the moving object 100 is self-propelled by the traveling unit 112 by electric power supplied from the battery 113. The traveling unit 112 is a three-wheeled vehicle including a pair of left and right front wheels 120 and a tail wheel (driven wheel) 121. The traveling unit 112 may be in another form, such as a four-wheeled vehicle. The moving object 100 includes a seat 111 for one person or two persons.

The traveling unit 112 includes a steering mechanism 123. The steering mechanism 123 is a mechanism of changing a steering angle of the pair of front wheels 120 by using motors 122a and 122b as a drive source. The advancing direction of the moving object 100 can be changed by changing the steering angle of the pair of front wheels 120. The tail wheel 121 is a driven wheel that does not individually have a drive source and is operated following the driving of the pair of front wheels 120. In addition, the tail wheel 121 is coupled to a vehicle body of the moving object 100 with a turning portion. The turning portion is rotated to change an orientation of the tail wheel 121 independently from the rotation of the tail wheel 121. In this manner, the moving object 100 according to the present embodiment adopts a differential two-wheeled mobility vehicle with the tail wheel, but is not limited thereto.

The moving object 100 includes a detection unit 114 that recognizes a plane in front of the moving object 100. The detection unit 114 is an external sensor that monitors the front of the moving object 100, and is an imaging apparatus that captures an image of the front of the moving object 100 in the case of the present embodiment. In the present embodiment, an example of a case will be described in which the detection unit 114 includes a stereo camera having an optical system such as two lenses and respective image sensors and a monocular camera. However, instead of or in addition to the imaging apparatus, a radar or a light detection and ranging (LiDAR) can also be used. In addition, an example in which the detection unit 114 is provided only in the front of the moving object 100 will be described in the present embodiment, but there is no intention to limit the present invention, and the detection unit 114 may be provided at the rear, the left, or the right of the moving object 100. In addition, instead of using a monocular camera, an image captured by one of the stereo cameras may be used.

The moving object 100 according to the present embodiment captures an image of a front region of the moving object 100 using the detection unit 114, and detects an obstacle from the captured image. Furthermore, the moving object 100 divides a peripheral region of the moving object 100 into grid cells, and controls the traveling while generating an occupancy grid map in which obstacle information is accumulated in each of the grid cells. Details of the occupancy grid map will be described later.

### <Control Configuration of Moving Object>

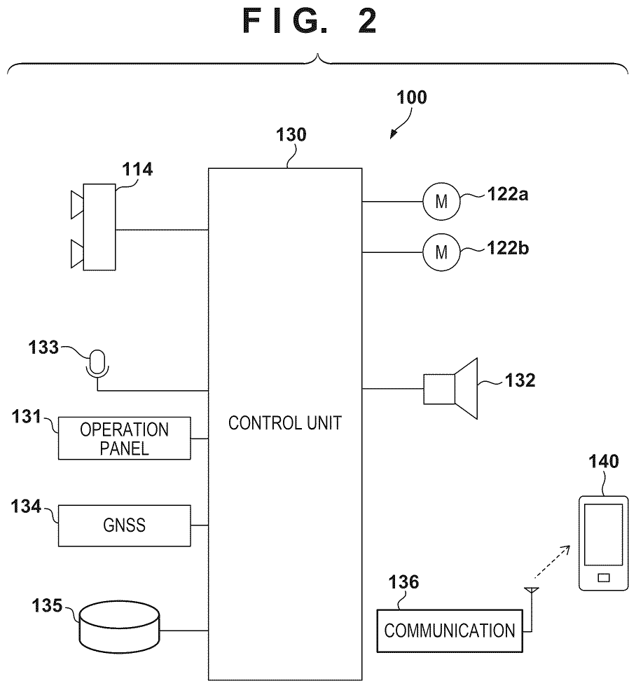

FIG. 2 is a block diagram of a control system of the moving object 100 according to the present embodiment. Here, a configuration necessary for carrying out the present invention will be mainly described. Therefore, any other configuration may be further included in addition to the configuration to be described below. In addition, in the present embodiment, a description will be given assuming that each unit to be described below is included in the moving object 100, but there is no intention to limit the present invention. A moving object control system including a plurality of devices may be implemented. For example, some functions of a control unit 130 may be realized by an information processing server connected to be capable of communicating with each other, or the detection unit 114 or a GNSS sensor 134 may be provided as an external device. The moving object 100 includes the control unit (ECU) 130. The control unit 130 includes a processor represented by a CPU, a storage device such as a semiconductor memory, an interface with an external device, and the like. The storage device stores a program executed by the processor, data used for processing by the processor, and the like. A plurality of sets of the processor, the storage device, and the interface may be provided for each function of the moving object 100 to be able to communicate with one another.

The control unit 130 acquires a detection result of the detection unit 114, input information of an operation panel 131, voice information input from a voice input apparatus 133, positional information from the GNSS sensor 134, and reception information via a communication unit 136, and executes corresponding processing. The control unit 130 performs control of the motors 122a and 122b (traveling control of the traveling unit 112), display control of the operation panel 131, notification to an occupant of the moving object 100 by voice of a speaker 132, and output of information.

The voice input apparatus 133 can collect voice of the occupant of the moving object 100. The control unit 130 can recognize the input voice and execute corresponding processing. The global navigation satellite system (GNSS) sensor 134 receives a GNSS signal, and detects a current position of the moving object 100. A storage apparatus 135 is a storage device that stores a captured image by the detection unit 114, obstacle information, a path generated in the past, an occupancy grid map, and the like. The storage apparatus 135 may also store a program to be executed by the processor, data used for processing by the processor, and the like. The storage apparatus 135 may store various parameters (for example, trained parameters of a deep neural network, hyperparameters, and the like) of a machine learning model for voice recognition or image recognition to be executed by the control unit 130.

The communication unit 136 communicates with a communication apparatus 140, which is an external apparatus, via wireless communication such as Wi-Fi or 5th generation mobile communication. The communication apparatus 140 is, for example, a smartphone, but is not limited thereto, and may be an earphone type communication terminal, a personal computer, a tablet terminal, a game machine, or the like. The communication apparatus 140 is connected to a network via wireless communication such as Wi-Fi or 5th generation mobile communication.

A user who owns the communication apparatus 140 can give an instruction to the moving object 100 via the communication apparatus 140. The instruction includes, for example, an instruction for calling the moving object 100 to a position desired by the user for joining. In a case of receiving the instruction, the moving object 100 sets a target position on the basis of the positional information included in the instruction. Note that, in addition to such an instruction, the moving object 100 can set a target position from the captured image of the detection unit 114, or can set a target position on the basis of an instruction received via the operation panel 131 from the user riding on the moving object 100. In a case of setting a target position from the captured image, for example, a person who raises his/her hand for the moving object 100 is detected in the captured image, and the position of the detected person is estimated and set as the target position.

### <Functional Configuration of Moving Object>

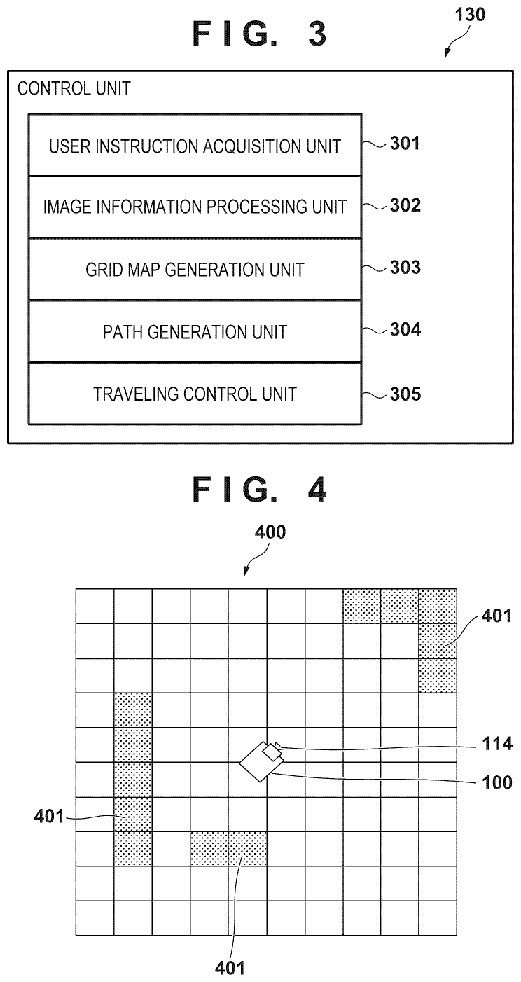

Next, the functional configuration of the moving object 100 according to the present embodiment will be described with reference to FIG. 3. The functional configuration described here is realized by, for example, the CPU in the control unit 130 reading a program stored in a memory such as a ROM into a RAM and executing the program. Note that the functional configuration described below describes only functions necessary for describing the present invention, and does not describe all of functional configurations actually included in the moving object 100. That is, the functional configuration of the moving object 100 according to the present invention is not limited to the functional configuration to be described below.

A user instruction acquisition unit 301 has a function of receiving an instruction from the user, and can receive a user instruction via the operation panel 131, a user instruction from an external apparatus such as the communication apparatus 140 via the communication unit 136, and an instruction by an utterance of the user via the voice input apparatus 133. As described above, the user instruction includes an instruction to set a target position (also referred to as a destination) of the moving object 100 and an instruction related to the traveling control of the moving object 100.

An image information processing unit 302 processes the captured image acquired by the detection unit 114. Specifically, the image information processing unit 302 creates a depth image from a stereo image acquired by the detection unit 114 to obtain a three-dimensional point cloud. Image data (also referred to as depth information) converted into the three-dimensional point cloud is used to detect an obstacle that hinders the traveling of the moving object 100. In addition, the image information processing unit 302 may include a machine learning model that processes image information, and may perform processing of a learning stage and processing of an inference stage of the machine learning model. For example, the image information processing unit 302 identifies an obstacle included in the captured image captured by the monocular camera. For example, the image information processing unit 302 can identify the type of the obstacle, and can identify whether the obstacle is a dynamic obstacle or a static obstacle determined in advance for each type of the obstacle. The dynamic obstacle is an autonomously movable obstacle and includes, for example, a vehicle or another traffic participant such as a pedestrian or a bicycle. In addition, the static obstacle is an obstacle that does not move autonomously, and includes, for example, an object such as a sign or a guardrail. The machine learning model of the image information processing unit 302 can perform processing of recognizing a three-dimensional object or the like included in the image information by performing computation of a deep learning algorithm using a deep neural network (DNN), for example.

A grid map generation unit 303 creates a grid map of a predetermined size (for example, in a region of 20 m×20 m with each cell of 10 cm×10 cm) on the basis of the image data (depth information) of the three-dimensional point cloud. This is intended to reduce the amount since the data amount of the three-dimensional point cloud is large and real-time processing is difficult. The grid map includes, for example, a grid map indicating a difference between a maximum height and a minimum height of an intra-grid point cloud (representing whether or not the cell is a step) and a grid map indicating a maximum height of the intra-grid point cloud from a reference point (representing a topography shape of the cell). Furthermore, the grid map generation unit 303 removes spike noise and white noise included in the generated grid map, detects an obstacle having a predetermined height or more, and generates an occupancy grid map indicating whether or not there is a three-dimensional object as the obstacle for each grid cell. In addition, as will be described later, the grid map generation unit 303 generates an occupancy grid map in which grid cells in which a dynamic obstacle exists and grid cells in which a static obstacle exists are identified.

A path generation unit 304 generates a travel path of the moving object 100 with respect to the target position set by the user instruction acquisition unit 301. Specifically, the path generation unit 304 generates a path using the occupancy grid map generated by the grid map generation unit 303 from the captured image of the detection unit 114 without requiring obstacle information of a high-precision map. Note that the detection unit 114 is a stereo camera that captures the image of the front region of the moving object 100, and thus, is not able to recognize obstacles in the other directions. Therefore, it is desirable that the moving object 100 stores detected obstacle information for a predetermined period in order to avoid a collision with an obstacle outside a viewing angle and a stack in a dead end. As a result, the moving object 100 can generate a path in consideration of both the obstacle detected in the past and the obstacle detected in real time.

In addition, the path generation unit 304 periodically generates a global path using the occupancy grid map, and periodically generates a local path to follow the global path. That is, a target position of the local path is determined by the global path. In addition, in the present embodiment, as a generation cycle of each path, the generation cycle of the global path is set to 100 ms, and the generation cycle of the local path is set to 50 ms, but the present invention is not limited thereto. As an algorithm for generating a global path, various algorithms such as a rapid-exploring random tree (RRT), a probabilistic road map (PRM), and A* are known. The path generation unit 304 can determine the global path by using information on grid cells in which the static obstacle exists in the occupancy grid map. On the other hand, in a case of generating a local path, the path generation unit 304 can use information on the grid cells in which the static obstacle exists and the grid cells in which the dynamic obstacle exists in the occupancy grid map. In this manner, it is possible to generate the global path using information on the stable obstacle, and to generate the local path that is a travelable path and avoids the approach to the dynamic obstacle.

A traveling control unit 305 controls the traveling of the moving object 100 in accordance with the local path. Specifically, the traveling control unit 305 controls the traveling unit 112 in accordance with the local path to control the speed and the angular velocity of the moving object 100. Furthermore, the traveling control unit 305 controls the traveling in response to various operations of a driver. In a case where a deviation occurs in a driving plan of the local path due to the driver's operation, the traveling control unit 305 may control the traveling by acquiring a new local path generated by the path generation unit 304 again, or may control the speed and the angular velocity of the moving object 100 so as to eliminate the deviation from the local path in use.

### <Occupancy Grid Map>

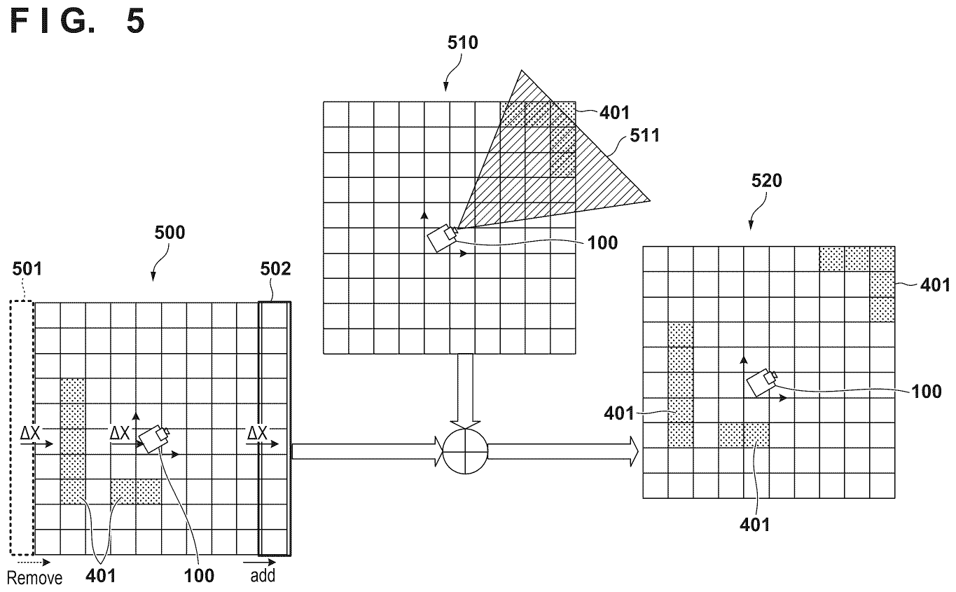

FIG. 4 illustrates an occupancy grid map 400 including obstacle information according to the present embodiment. Since the moving object 100 according to the present embodiment travels without depending on the obstacle information of a high-precision map, the obstacle information is entirely acquired from a recognition result of the detection unit 114. At this time, it is necessary to store the obstacle information in order to avoid a collision with an obstacle outside a viewing angle or a stack in a dead end. In the present embodiment, as a method of storing the obstacle information, the occupancy grid map is used from the viewpoint of reduction in the amount of information of a three-dimensional point cloud of a stereo image and ease of handling in path planning.

The grid map generation unit 303 according to the present embodiment divides a peripheral region of the moving object 100 into grid cells, and generates an occupancy grid map including information indicating the presence or absence of an obstacle for each of the divided regions of the grid (grid cells). Note that an example in which a predetermined region is divided into grid cells will be described here. However, instead of being divided into grid cells, the predetermined region may be divided into other shapes to create an occupancy map indicating the presence or absence of an obstacle for each divided region. In the occupancy grid map 400, a region having a size of, for example, 40 m×40 m or 20 m×20 m around the moving object 100 is set as the peripheral region, the region is divided into grid cells of 20 cm×20 cm or 10 cm×10 cm, and the information of the grid cells is dynamically set in accordance with movement of the moving object 100. That is, the occupancy grid map 400 is a region that is shifted such that the moving object 100 is always at the center in accordance with the movement of the moving object 100 and varies in real time. Note that any size of the region can be set on the basis of hardware resources of the moving object 100.

In addition, in the occupancy grid map 400, presence/absence information of an obstacle detected from the captured image by the detection unit 114 is defined for each grid cell. As the presence/absence information, for example, a travelable region is defined as “0”, and a non-travelable region (that is, presence of an obstacle) is defined as “1”. Note that in the occupancy grid map 400, type information (for example, a dynamic obstacle or a static obstacle) of an obstacle may be set for each grid cell. Alternatively, the occupancy grid map may include an occupancy grid map of dynamic obstacles in which presence/absence information of dynamic obstacles is defined for each grid cell and an occupancy grid map of static obstacles in which presence/absence information of static obstacles is defined for each grid cell. In FIG. 4, reference numeral 401 indicates a grid cell in which an obstacle exists. A region where an obstacle exists indicates a region through which the moving object 100 is not able to pass, and includes, for example, a three-dimensional object of 5 cm or more. Therefore, the moving object 100 generates a path to avoid these obstacles 401.

### <Accumulation of Obstacle Information>

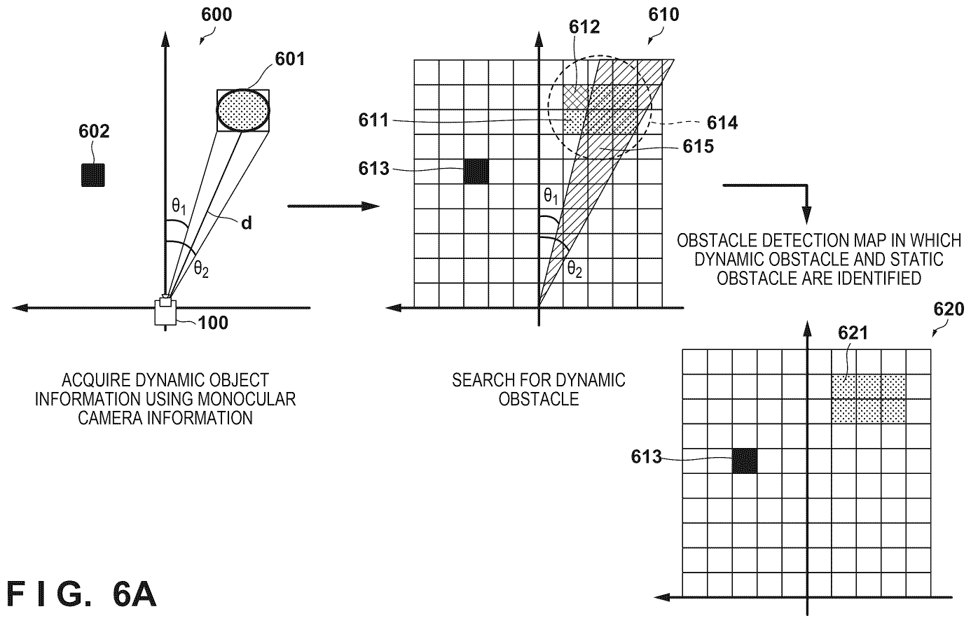

The accumulation of the obstacle information in the occupancy grid map according to the present embodiment will be described with reference to FIG. 5. Reference numeral 500 indicates a local map that moves in accordance with the movement of the moving object 100. The local map 500 is shifted in accordance with the movement of the moving object 100 with respect to an x-axis direction and a y-axis direction on the grid map. The local map 500 illustrates a state in which a dotted line region of 501 is removed and a solid line region of 502 is added according to a movement amount Δx of the moving object 100 in the x-axis direction, for example. The region to be removed is a region opposite to the advancing direction of the moving object 100, and the region to be added is a region in the advancing direction. Similarly, also in the y-axis direction, regions are also removed and added in accordance with the movement of the moving object 100.

In addition, the local map 500 accumulates the obstacle information detected in the past. Note that in a case where an obstacle exists in a grid cell included in the removed region, the obstacle information is removed from the local map 500, but is desirably held separately from the local map 500 for a certain period. Such information is effective, for example, in a case where the moving object 100 changes a course so that the removed region is included in the local map 500 again, and the avoidance accuracy of the moving object 100 with respect to the obstacle can be improved. In addition, by using the accumulated information, it is unnecessary to detect the obstacle again and it is possible to reduce a processing load.

Furthermore, before the local map 500 is added to an obstacle detection map 510 to be described later, forgetting processing is performed according to a forgetting rate set for each grid cell. In a case where a dynamic obstacle involving movement is detected, in a case where the obstacle information detected in the past and accumulated in the grid cells is continuously held as it is, erroneous detection that an obstacle exists in all the grid cells along a movement trajectory of the obstacle may occur. Therefore, in order to avoid erroneously determining that an obstacle exists in the grid cells through which the obstacle has already passed, it is necessary to forget the accumulated information of the obstacle after a certain period has elapsed. In the present embodiment, the forgetting rate is individually set for each grid cell. Here, the forgetting rate indicates how much accumulated obstacle information is held. For example, according to the present embodiment, the occupancy grid map is periodically generated, and the forgetting rate indicates over how many cycles obstacle information is stored.

The forgetting rate set for each grid cell can be set in various modes. For example, in the present embodiment, the forgetting rate for forgetting the accumulated obstacle information can be set to a different value according to the type of the obstacle. For example, the forgetting rate is set to a different value between each grid cell in which the type of the obstacle is a dynamic obstacle and each grid cell in which the type of the obstacle is a static obstacle. Since the dynamic obstacle moves or has the potential to move, the forgetting rate needs to be high in order to follow the movement. That is, the forgetting rate for the dynamic obstacle is set to a value higher than the forgetting rate for the static obstacle that does not move. With this setting, it is possible to quickly forget the obstacle information and take measures against the dynamic obstacle involving movement.

In addition, the forgetting rate for forgetting the accumulated obstacle information may be set to a further different value between each grid cell included in a viewing angle range 511 and a grid cell not included in the viewing angle range 511. For example, as the forgetting rate for a grid cell overlapping the viewing angle range 511, a forgetting rate higher than the forgetting rate for other grid cells may be set. Here, a grid cell overlapping the viewing angle range 511 is a grid cell in which a predetermined region or more in the grid cell overlaps the viewing angle range 511. The size of the predetermined region is arbitrary, and can be set to 1 to 100%, for example.

Reference numeral 510 indicates an obstacle detection map indicating detection information of the obstacle existing in front of the moving object 100 from the captured image captured by the detection unit 114 of the moving object 100. The obstacle detection map 510 indicates real-time information, and is periodically generated on the basis of the captured image acquired from the detection unit 114. In the viewing angle range 511 of the detection unit 114, which is a front region of the moving object 100, it is desirable to perform the update using the obstacle detection map 510 generated periodically, instead of fixing and accumulating the obstacles detected in the past. As a result, the moving obstacles can also be recognized, and generation of a path with avoidance more than necessary can be prevented. In the obstacle detection map 510, type information (for example, a dynamic obstacle or a static obstacle) of an obstacle may be set for each grid cell. Alternatively, the obstacle detection map 510 may include an obstacle detection map of dynamic obstacles in which presence/absence information of dynamic obstacles is defined for each grid cell and an obstacle detection map of static obstacles in which presence/absence information of static obstacles is defined for each grid cell. On the other hand, for a rear region (strictly speaking, outside the viewing angle of the detection unit 114) of the moving object 100, the information on the obstacles detected in the past is accumulated as illustrated in the local map 500. As a result, for example, in a case where an obstacle is detected in the front region and a detour path is generated, it is possible to easily generate a path that avoids the collision with the passed obstacle.

Reference numeral 520 indicates an occupancy grid map generated by adding the local map 500 and the obstacle detection map 510. In this manner, the occupancy grid map 520 is generated as a grid map obtained by combining the local map and the obstacle detection information varying in real time with the obstacle information detected and accumulated in the past.

### <Setting of Grid Cells of Dynamic Obstacle and Static Obstacle>

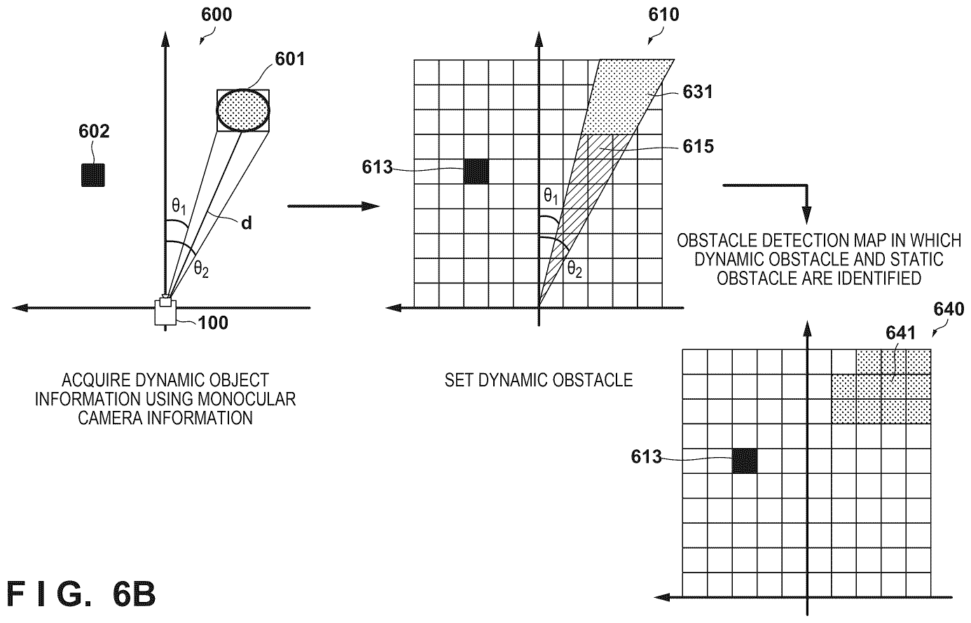

The setting of grid cells of a dynamic obstacle and a static obstacle will be described with reference to FIG. 6A. Reference numeral 600 indicates a state in which a plane on which the moving object 100 travels is viewed from above. The moving object 100 is located at the origin of the coordinate system, an object 601 is, for example, a person, and an object 602 is, for example, a triangular cone arranged on a road. The object 601 and the object 602 are included in the captured image captured by a monocular camera of the detection unit 114. The image information processing unit 302 performs object recognition processing using the captured image, and estimates the type of the object. Since the object 601 is estimated to be a person and the object 602 is estimated to be a triangular cone by the image information processing unit 302, the object 601 and the object 602 are identified as a dynamic obstacle and a static obstacle, respectively. The image information processing unit 302 identifies a distance d from the moving object 100 to the object 601 and a boundary region (boundary) of the object 601. The image information processing unit 302 can obtain a rotation angle θ1 of a straight line, which passes through a first end portion (an end of the boundary region) of the object 601, from, for example, an optical axis direction by identifying the boundary region of the object 601. Similarly, the image information processing unit 302 can obtain a rotation angle θ2 of a straight line, which passes through a second end portion (the other end of the boundary region) of the object 601, from, for example, the optical axis direction. Note that the rotation angles θ1 and 02 are rotation angles of the polar coordinate system.

Next, the grid map generation unit 303 searches for a dynamic obstacle on the basis of a grid map 610 obtained on the basis of the depth information obtained from the stereo image and the information obtained by the image information processing unit 302 (from the captured image of the monocular camera). In the grid map 610, “1” of presence/absence information is set in the grid cells in which an obstacle exists (that is, grid indicating occupancy of the obstacle) in depth information obtained from the stereo image. The grid cells indicating the presence of the obstacle are grid cells 611 (five), a grid cell 612 (one), and a grid cell 613 (one). The grid map generation unit 303 superimposes a region 615 defined by rotation angles θ1 and θ2 (boundary of the dynamic obstacle) on the grid map 610, and identifies obstacle grid cells having an area equal to or larger than a predetermined area overlapping the region 615. That is, the grid map generation unit 303 associates the region surrounded from the end to the end of the dynamic obstacle obtained in the captured image, with the obstacle grid cells in the grid map 610. With this processing, the grid map generation unit 303 can set the five grid cells indicated by the grid cells 611 as grid cells in which the dynamic obstacle exists. The grid map generation unit 303 further integrates, among the grid cells in which the obstacle exists, the grid cells adjacent to the grid cells 611 as the grid cells in which the dynamic obstacle exists. In this manner, the grid cells 611 and the grid cell 612 can be set as the grid cells in which one dynamic obstacle exists. Note that the grid map generation unit 303 may integrate, among the grid cells in which the obstacle exists, the grid cells in the vicinity of the grid cells 611 as the grid cells in which the dynamic obstacle exists. In this manner, a region hidden by the dynamic obstacle identified in the captured image can be treated as the region of the dynamic obstacle. In a case where a high forgetting rate is set in the grid cells of the dynamic obstacle, the region hidden by the dynamic obstacle is forgotten earlier than the static obstacle, and thus the influence of the point cloud noise by the obstacle is also forgotten earlier.

However, the grid map generation unit 303 does not set, among the grid cells in which the obstacle exists, a grid cell (for example, 613) at a position farther than a distance threshold from the grid cells (that is, 611 and 612) in which the dynamic obstacle exists, as a grid cell associated with the same dynamic obstacle. In this manner, it is possible to integrate dynamic obstacles within an appropriate range, and it is possible to prevent unnecessary integration of grid cells of obstacles.

Furthermore, the grid map generation unit 303 may set a grid cell of an obstacle, which is not set as the dynamic obstacle, as a grid cell in which a static obstacle exists. For example, the grid cell 613 is a grid cell in which an obstacle exists, but since this region does not overlap the region 615 and is not in the vicinity of the grid cell in which a dynamic obstacle exists, the grid cell 613 is set as the grid cell in which the static obstacle exists.

With such processing, it is possible to generate an obstacle detection map 620 in which the dynamic obstacle and the static obstacle are identified. As described above, the grid cell 613 is set as a grid cell in which the static obstacle exists, and grid cells 621 are set as grid cells in which the dynamic obstacle exists. Note that, in the example described above with reference to FIG. 6A, an example has been described in which one obstacle detection map in which a grid cell in which the static obstacle exists and the grid cell in which the dynamic obstacle exists are set is generated. However, the grid map generation unit 303 may generate each of a first obstacle detection map in which a grid cell in which the static obstacle exists is set and a second obstacle detection map in which a grid cell in which the dynamic obstacle exists is set.

Another example of the setting of grid cells of the dynamic obstacle and the static obstacle according to the present embodiment will be described with reference to FIG. 6B. Note that reference numeral 600 is similar to that in FIG. 6A, and the image information processing unit 302 obtains the distance to the object 601 and the rotation angles θ1 and θ2 on the basis of the captured image by the above-described processing.

Next, the grid map generation unit 303 sets the grid cells of the dynamic obstacle on the basis of the information obtained by the image information processing unit 302 (from the captured image of the monocular camera). In the grid map 610, “1” of presence/absence information is set in a grid cell in which an obstacle exists (that is, a grid cell indicating occupancy of the obstacle) in depth information obtained from the stereo image. The grid cells indicating the presence of the obstacle are the grid cells 611 (five), the grid cell 612 (one), and the grid cell 613 (one) as in FIG. 6A, but in FIG. 6B, the grid cells 611 (five) and the grid cell 612 (one) are not illustrated so as not to complicate the description. The grid map generation unit 303 superimposes the region 615 defined by rotation angles θ1 and θ2 (boundary of the dynamic obstacle) on the grid map 610. Then, a region 631 of which the distance to the object 601 is greater than the distance d and which is defined by the rotation angles θ1 and θ2 (boundary of the dynamic obstacle) is set as a region where the dynamic obstacle exists. With this processing, the grid map generation unit 303 can set the grid cells that the region 631 overlaps, as the grid cells in which the dynamic obstacle exists. For example, in the example illustrated in FIG. 6B, the grid cells that the region 631 overlaps even slightly are set as grid cells in which the dynamic obstacle exists. In this manner, a region hidden by the dynamic obstacle identified in the captured image can be treated as the region of the wide dynamic obstacle. In a case where a high forgetting rate is set in the grid cells of the dynamic obstacle, the region hidden by the dynamic obstacle is forgotten earlier than the static obstacle, and thus the influence of the point cloud noise by the obstacle is also forgotten earlier.

With such processing, it is possible to generate an obstacle detection map 640 in which the dynamic obstacle and the static obstacle are identified. As described above, the grid cell 613 is set as a grid cell in which the static obstacle exists, and grid cells 641 are set as grid cells in which the dynamic obstacle exists. Note that, also in the example illustrated in FIG. 6B, an example has been described in which one obstacle detection map in which the grid cells in which the static obstacle exists and the grid cells in which the dynamic obstacle exists are set is generated. However, the grid map generation unit 303 may generate each of a first obstacle detection map in which the grid cells in which the static obstacle exists is set and a second obstacle detection map in which the grid cells in which the dynamic obstacle exists is set.

### <Path Generation>

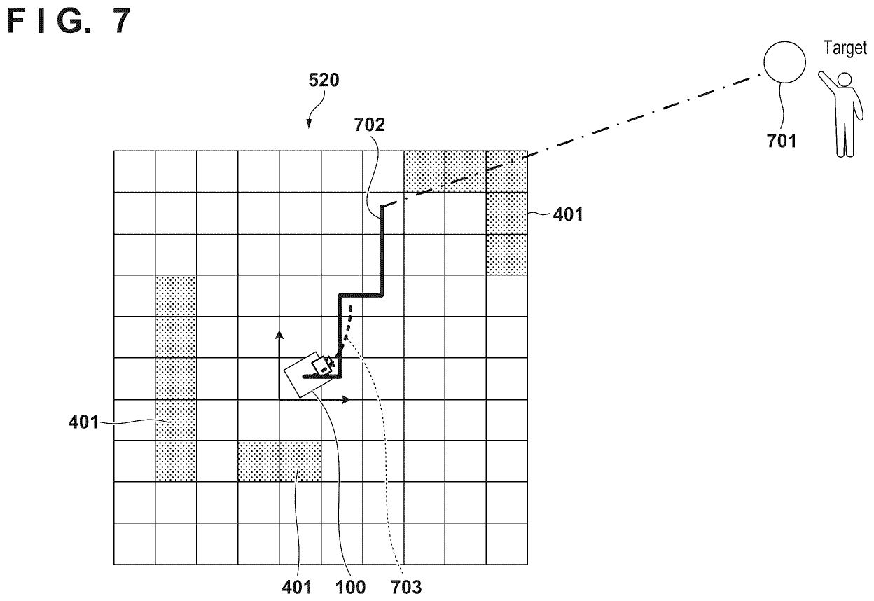

A travel path generated in the moving object 100 according to the present embodiment will be described with reference to FIG. 7. The path generation unit 304 according to the present embodiment periodically generates a global path 702 using an occupancy grid map in accordance with a set target position 701, and periodically generates a local path 703 so as to follow the global path.

The target position 701 is set based on various instructions. For example, an instruction from an occupant riding on the moving object 100 and an instruction from a user outside the moving object 100 are included. The instruction from the occupant is performed via the operation panel 131 or the voice input apparatus 133. The instruction via the operation panel 131 may be a method of designating a predetermined grid cell of a grid map displayed on the operation panel 131. In this case, a size of each grid cell may be set to be large, and the grid cell may be selectable from a wider range of the map. The instruction via the voice input apparatus 133 may be an instruction using a surrounding reference point as a mark. The reference point may include pedestrians, signboards, signs, equipment installed outdoors such as vending machines, building components such as windows and entrances, roads, vehicles, two-wheeled vehicles, and the like included in utterance information. In a case of receiving the instruction via the voice input apparatus 133, the path generation unit 304 detects the reference point designated from the captured image acquired by the detection unit 114, and sets the reference point as the target position.

A machine learning model is used for these voice recognition and image recognition. The machine learning model performs, for example, computation of a deep learning algorithm using a deep neural network (DNN) to recognize a place name, a landmark name such as a building, a store name, a reference point name, and the like included in the utterance information and the image information. The DNN for the voice recognition becomes a learned state by performing the processing of the learning stage, and can perform recognition processing (processing of the inference stage) for new utterance information by inputting the new utterance information to the learned DNN. In addition, the DNN for the image recognition can recognize pedestrians, signboards, signs, equipment installed outdoors such as vending machines, building components such as windows and entrances, roads, vehicles, two-wheeled vehicles, and the like included in the image.

In addition, regarding the instruction from the user outside the moving object 100, it is also possible to notify the moving object 100 of the instruction via the owned communication apparatus 140 via the communication unit 136 or call the moving object 100 by an operation such as raising a hand toward the moving object 100 as illustrated in FIG. 7. The instruction using the communication apparatus 140 is performed by an operation input or a voice input similarly to the instruction from the occupant.

In a case where the target position 701 is set, the path generation unit 304 generates the global path 702 using the generated occupancy grid map. Various algorithms such as RRT, PRM, and A* are known as generation method for the global path, but any method may be used. Then, the path generation unit 304 generates the local path 703 so as to follow the generated global path 702. As a method of local path planning, there are various methods such as a dynamic window approach (DWA), model predictive control (MPC), clothoid tentacles, and proportional-integral-differential (PID) control.

### <Basic Control of Moving Object>

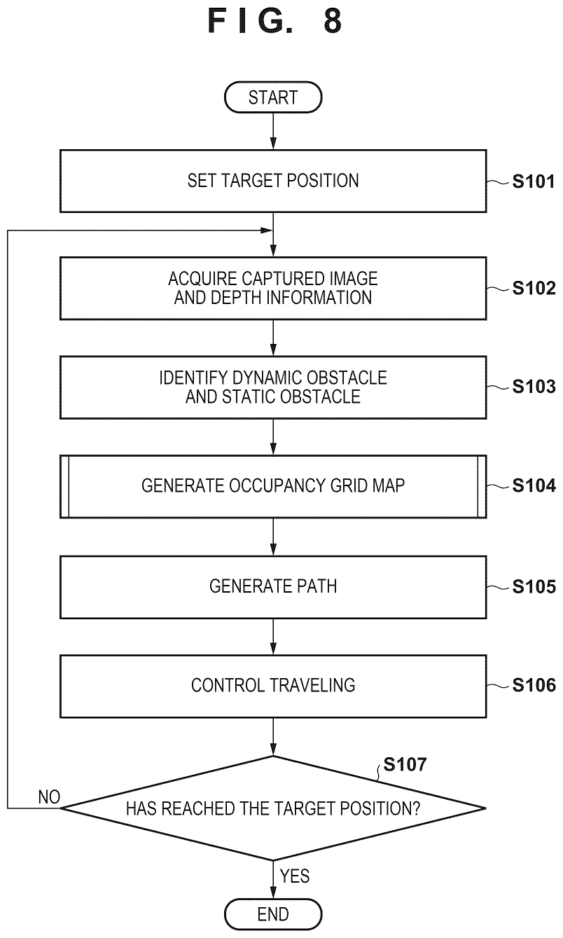

FIG. 8 is a flowchart illustrating basic control of the moving object 100 according to the present embodiment. Processing to be described below is achieved by, for example, the CPU in the control unit 130 reading a program stored in a memory such as a ROM into a RAM and executing the program.

In step S101, the control unit 130 sets a target position of the moving object 100 on the basis of a user instruction received by the user instruction acquisition unit 301. The user instruction can be received in various methods as described above. Subsequently, in step S102, the control unit 130 acquires the captured image and the depth information. Specifically, the control unit 130 captures an image of the front region of the moving object 100 by the detection unit 114 to acquire the captured image. The acquired captured image is processed by the image information processing unit 302, and a depth image is created and formed into a three-dimensional point cloud (depth information is generated).

In step S103, the control unit 130 causes the image information processing unit 302 to identify the dynamic obstacle and the static obstacle from the captured image of the monocular camera. The image information processing unit 302 can identify the distance d to the dynamic obstacle and the rotation angles θ1 and θ2 described above for the dynamic obstacle.

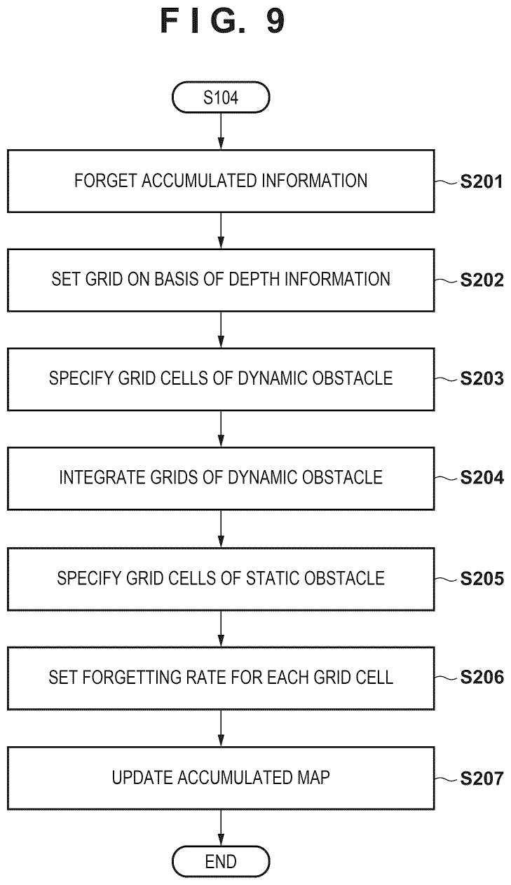

In step S104, the control unit 130 generates the occupancy grid map by the grid map generation unit 303. For example, an obstacle that is a three-dimensional object of, for example, 5 cm or more is detected from the image formed into a three-dimensional point cloud, and a grid map of a predetermined region centered on the moving object 100 is generated according to the detected obstacle and the positional information of the moving object 100. In addition, the grid map generation unit 303 generates an obstacle detection map in which the dynamic obstacle and the static obstacle are identified by the method described with reference to FIG. 6A or 6B, and adds the obstacle detection map to the local map 500 to generate an occupancy grid map. A detailed method will be described with reference to FIG. 9.

Next, in step S105, the control unit 130 causes the path generation unit 304 to generate the travel path of the moving object 100. As described above, the path generation unit 304 generates the global path using the occupancy grid map, and generates the local path according to the generated global path. Subsequently, in step S106, the control unit 130 determines the speed and angular velocity of the moving object 100 according to the generated local path, and controls traveling. Thereafter, in step S107, the control unit 130 determines whether or not the moving object 100 has reached the target position on the basis of positional information from the GNSS sensor 134, and in a case where the moving object 100 has not reached the target position, the control unit 130 returns the processing to step S102 to repeatedly perform the processing of generating the path and controlling traveling while updating the occupancy grid map. On the other hand, in a case where the moving object 100 has reached the target position, the processing of this flowchart ends.

### <Generation Method of Occupancy Grid Map>

FIG. 9 is a flowchart illustrating a detailed processing procedure of the generation processing (step S104) of the occupancy grid map according to the present embodiment. Processing to be described below is achieved by, for example, the CPU in the control unit 130 reading a program stored in a memory such as a ROM into a RAM and executing the program.

In step S201, the control unit 130 first forgets the accumulated information regarding the obstacle. The forgetting processing can perform any processing, but a new accumulated value is calculated by multiplying the accumulated value of the obstacle accumulated for each grid cell by the forgetting rate (for example, a numerical value between 0 and 1) set previously (for example, in step S206) for each grid cell. In a case where the forgetting processing is executed, for example, the local map 500 illustrated in FIG. 5 is generated.

Next, in step S202, the control unit 130 sets the grid on the basis of the depth information. For example, the grid map generation unit 303 detects the obstacle that is a three-dimensional object of, for example, 5 cm or more from the image (depth information) formed into a three-dimensional point cloud, and generates the grid map (for example, the grid map 610 illustrated in FIG. 6A) of a predetermined region centered on the moving object 100 according to the detected obstacle and the positional information of the moving object 100.

In step S203, the control unit 130 specifies the grid cells of the dynamic obstacle by the grid map generation unit 303. For example, the grid map generation unit 303 specifies the grid cells (for example, the grids 611) of the dynamic obstacle using the information on the dynamic obstacle identified in step S103 and the grid map generated in step S202 by the method described above in FIG. 6A, for example. In step S204, the control unit 130 integrates the adjacent or nearby grid cells of the obstacle into the grid cells of the dynamic obstacle, for example by the method described above in FIG. 6A. Of course, the method of identifying the grid cells of the dynamic obstacle may be the method described above in FIG. 6B.

In step S205, the control unit 130 specifies a grid of the static obstacle by the grid map generation unit 303. For example, the grid map generation unit 303 specifies, among the grids of the obstacle, a grid cell in which no dynamic obstacle is set as a grid cell of the static obstacle. In step S206, the control unit 130 sets the forgetting rate for each grid cell. For example, the grid map generation unit 303 sets the forgetting rate for forgetting the accumulated obstacle information to a different value according to the type of the obstacle. In this case, the forgetting rate for the dynamic obstacle is set to a value higher than the forgetting rate for the static obstacle. By the processing of steps S202 to S206, the grid map generation unit 303 generates the obstacle detection map 620 illustrated in FIG. 6A, for example.

In step S207, the control unit 130 generates the occupancy grid map in which the obstacle information is updated by, for example, adding the map subjected to the forgetting processing in step S201 and the obstacle detection map generated in steps S202 to S206. In a case where the processing of step S207 ends, the control unit 130 ends the processing of this flowchart, and advances the processing to step S105. Note that the processing of steps S201 to S207 is periodically performed, and is performed at a cycle of 10 Hz, for example.

As described above, in the above-described embodiment, the image information processing unit 302 identifies the dynamic obstacle included in the captured image by using the captured image. The grid map generation unit 303 generates an occupancy map indicating occupancy of an obstacle for each divided region (grid cell) obtained by dividing a peripheral region of a moving object on the basis of the depth information, and the occupancy map includes a grid cell in which the static obstacle is set and a grid cell in which the dynamic obstacle is set. In order to specify the grid cells in which the dynamic obstacle is set, the grid map generation unit 303 sets grid cells in a depth direction that is away from the moving object from the position of the dynamic obstacle identified in the captured image, as the grid cells of the dynamic obstacle. Then, the grid cells of the dynamic obstacle are forgotten according to the forgetting rate higher than that of the static obstacle. In this manner, a region hidden by the dynamic obstacle identified in the captured image can be treated as the region of the dynamic obstacle, and the influence of the point cloud noise due to the obstacle occurring in this region is also quickly forgotten. Accordingly, it is possible to reduce the influence of the point cloud noise due to the dynamic obstacle around the moving object.

### Summary of Embodiments

### (Item 1)

A moving object control system comprising:
one or more processors; and
a memory storing instructions which, when the instructions are executed by the one or more processors, cause the moving object control system to function as:
an acquisition unit configured to acquire a captured image captured by a moving object, and depth information of an environment captured in the captured image;
an identification unit configured to identify a dynamic obstacle that is autonomously movable and included in the captured image by using the captured image; and
a map generation unit configured to generate an occupancy map indicating occupancy of an obstacle for each divided region obtained by dividing a peripheral region of the moving object, on a basis of the depth information, wherein
the occupancy map includes a first divided region indicating occupancy of the dynamic obstacle forgotten according to a forgetting rate higher than a forgetting rate of a static obstacle that does not autonomously move, and
the map generation unit sets the divided region in a depth direction that is away from the moving object from a position of the identified dynamic obstacle, as the first divided region indicating the occupancy of the dynamic obstacle.

According to the embodiment, a region hidden by the dynamic obstacle identified in the captured image can be treated as the region of the dynamic obstacle, and the influence of the point cloud noise due to the obstacle occurring in this region is also quickly forgotten. Accordingly, it is possible to reduce the influence of the point cloud noise due to the dynamic obstacle around the moving object.

### (Item 2)

The moving object control system according to item 1, wherein the map generation unit generates a first occupancy map including the first divided region indicating the occupancy of the dynamic obstacle, and a second occupancy map including a second divided region indicating occupancy of the static obstacle.

According to the embodiment, an occupancy map representing the occupancy by the dynamic obstacle and an occupancy map representing the occupancy by the static obstacle can be separately provided.

### (Item 3)

The moving object control system according to item 1, wherein the map generation unit generates a third occupancy map including the first divided region indicating the occupancy of the dynamic obstacle and a second divided region indicating occupancy of the static obstacle.

According to the embodiment, the occupancy by the dynamic obstacle and the occupancy by the static obstacle can be made into one occupancy map.

### (Item 4)

The moving object control system according to item 1, wherein the map generation unit specifies which divided region is the first divided region indicating the occupancy of the dynamic obstacle, from among the divided regions indicating the occupancy of the obstacle and specified on a basis of the depth information.

According to the embodiment, the region of the dynamic obstacle obtained in the captured image can be associated with the region of the obstacle in the grid map specified by the depth information.

### (Item 5)

The moving object control system according to item 4, wherein the map generation unit sets, as the first divided region indicating the occupancy of the dynamic obstacle, the divided region in the depth direction that is away from the moving object from the position of the identified dynamic obstacle, from among the divided regions indicating the occupancy of the obstacle and specified on a basis of the depth information.

According to the embodiment, the region hidden by the dynamic obstacle identified in the captured image can be treated as the region of the dynamic obstacle.

### (Item 6)

The moving object control system according to item 5, wherein the map generation unit integrates, as the first divided region for the same dynamic obstacle, the divided region adjacent to the first divided region indicating the occupancy of the dynamic obstacle, from among the divided regions indicating the occupancy of the obstacle and specified on a basis of the depth information.

According to the embodiment, adjacent regions of the obstacle can be integrated as the regions of one dynamic obstacle.

### (Item 7)

The moving object control system according to item 6, wherein the map generation unit does not set, as the first divided region for the same dynamic obstacle, the divided region located farther than a threshold from the first divided region indicating the occupancy of the dynamic obstacle, from among the divided regions indicating the occupancy of the obstacle and specified on a basis of the depth information.

According to the embodiment, it is possible to integrate the dynamic obstacles within an appropriate range, and it is possible to prevent unnecessary integration of grid cells of obstacles.

### (Item 8)

The moving object control system according to item 1, wherein the divided region in the depth direction that is away from the moving object from the position of the identified dynamic obstacle includes a region of which a depth is greater than a depth from the moving object to the identified dynamic obstacle, from among regions defined by boundaries of the identified dynamic obstacle.

According to the embodiment, the region hidden by the dynamic obstacle identified in the captured image can be treated as the region of the wide dynamic obstacle.

### (Item 9)

The moving object control system according to item 1, wherein the instructions further cause the moving object control system to function as:
an accumulation unit configured to accumulate information on the obstacle detected in the past for each divided region obtained by dividing the peripheral region of the moving object; and
a forgetting unit configured to cause the accumulated information on the obstacle to be forgotten according to the forgetting rate assigned for each divided region.

According to the embodiment, it is possible to cope with a change in the obstacle.

### (Item 10)

The moving object control system according to item 1, wherein the dynamic obstacle is a vehicle or another traffic participant.

According to the embodiment, it is possible to avoid contact or approach with a vehicle or another traffic participant.

### (Item 11)

The moving object control system according to item 1, wherein the acquisition unit acquires the captured image captured by a monocular imaging apparatus, and the depth information obtained from a stereo image captured by a plurality of imaging apparatuses.

According to the embodiment, it is possible to realize a technique of the grid map in consideration of the dynamic obstacle with an inexpensive configuration by the imaging apparatus and the image processing.

### (Item 12)

The moving object control system according to item 1, wherein the identification unit further identifies a distance from the moving object to the dynamic obstacle and a boundary region of the dynamic obstacle on a basis of the captured image.

According to the embodiment, three-dimensional information for specifying the occupied regions of the dynamic obstacle can be acquired from the captured image.

The invention is not limited to the foregoing embodiments, and various variations/changes are possible within the spirit of the invention.

What is claimed is:

1. A moving object control system comprising:
one or more processors; and
a memory storing instructions which, when the instructions are executed by the one or more processors, cause the moving object control system to function as:
an acquisition unit configured to acquire a captured image captured by a moving object, and depth information of an environment captured in the captured image;
an identification unit configured to identify a dynamic obstacle that is autonomously movable and included in the captured image by using the captured image; and
a map generation unit configured to generate an occupancy map indicating occupancy of an obstacle for each divided region obtained by dividing a peripheral region of the moving object, on a basis of the depth information, wherein
the occupancy map includes a first divided region indicating occupancy of the dynamic obstacle forgotten according to a forgetting rate higher than a forgetting rate of a static obstacle that does not autonomously move, and
the map generation unit sets the divided region in a depth direction that is away from the moving object from a position of the identified dynamic obstacle, as the first divided region indicating the occupancy of the dynamic obstacle.

2. The moving object control system according to claim 1, wherein the map generation unit generates a first occupancy map including the first divided region indicating the occupancy of the dynamic obstacle, and a second occupancy map including a second divided region indicating occupancy of the static obstacle.

3. The moving object control system according to claim 1, wherein the map generation unit generates a third occupancy map including the first divided region indicating the occupancy of the dynamic obstacle and a second divided region indicating occupancy of the static obstacle.

4. The moving object control system according to claim 1, wherein the map generation unit specifies which divided region is the first divided region indicating the occupancy of the dynamic obstacle, from among the divided regions indicating the occupancy of the obstacle and specified on a basis of the depth information.

5. The moving object control system according to claim 4, wherein the map generation unit sets, as the first divided region indicating the occupancy of the dynamic obstacle, the divided region in the depth direction that is away from the moving object from the position of the identified dynamic obstacle, from among the divided regions indicating the occupancy of the obstacle and specified on a basis of the depth information.

6. The moving object control system according to claim 5, wherein the map generation unit integrates, as the first divided region for the same dynamic obstacle, the divided region adjacent to the first divided region indicating the occupancy of the dynamic obstacle, from among the divided regions indicating the occupancy of the obstacle and specified on a basis of the depth information.

7. The moving object control system according to claim 6, wherein the map generation unit does not set, as the first divided region for the same dynamic obstacle, the divided region located farther than a threshold from the first divided region indicating the occupancy of the dynamic obstacle, from among the divided regions indicating the occupancy of the obstacle and specified on a basis of the depth information.

8. The moving object control system according to claim 1, wherein the divided region in the depth direction that is away from the moving object from the position of the identified dynamic obstacle includes a region of which a depth is greater than a depth from the moving object to the identified dynamic obstacle, from among regions defined by boundaries of the identified dynamic obstacle.

9. The moving object control system according to claim 1, wherein the instructions further cause the moving object control system to function as:
an accumulation unit configured to accumulate information on the obstacle detected in the past for each divided region obtained by dividing the peripheral region of the moving object; and
a forgetting unit configured to cause the accumulated information on the obstacle to be forgotten according to the forgetting rate assigned for each divided region.

10. The moving object control system according to claim 1, wherein the dynamic obstacle is a vehicle or another traffic participant.

11. The moving object control system according to claim 1, wherein the acquisition unit acquires the captured image captured by a monocular imaging apparatus, and the depth information obtained from a stereo image captured by a plurality of imaging apparatuses.

12. The moving object control system according to claim 1, wherein the identification unit further identifies a distance from the moving object to the dynamic obstacle and a boundary region of the dynamic obstacle on a basis of the captured image.

13. A control method for a moving object control system, the control method comprising:
acquiring a captured image captured by a moving object, and depth information of an environment captured in the captured image;
identifying a dynamic obstacle that is autonomously movable and included in the captured image by using the captured image; and
generating an occupancy map indicating occupancy of an obstacle for each divided region obtained by dividing a peripheral region of the moving object, on a basis of the depth information, wherein
the occupancy map includes a first divided region indicating occupancy of the dynamic obstacle forgotten according to a forgetting rate higher than a forgetting rate of a static obstacle that does not autonomously move, and
the generating the occupancy map includes setting the divided region in a depth direction that is away from the moving object from a position of the identified dynamic obstacle, as the first divided region indicating the occupancy of the dynamic obstacle.

14. A non-transitory computer-readable storage medium of storing a program for causing a computer to function as each unit of a moving object control system, wherein
the moving object control system includes
an acquisition unit configured to acquire a captured image captured by a moving object, and depth information of an environment captured in the captured image,
an identification unit configured to identify a dynamic obstacle that is autonomously movable and included in the captured image by using the captured image, and
a map generation unit configured to generate an occupancy map indicating occupancy of an obstacle for each divided region obtained by dividing a peripheral region of the moving object, on a basis of the depth information,
the occupancy map includes a first divided region indicating occupancy of the dynamic obstacle forgotten according to a forgetting rate higher than a forgetting rate of a static obstacle that does not autonomously move, and
the map generation unit sets the divided region in a depth direction that is away from the moving object from a position of the identified dynamic obstacle, as the first divided region indicating the occupancy of the dynamic obstacle.
